(19) United States
(12) Patent Application Publication
(10) Pub. No.: US 2007/0050507 A1
(43) Pub. Date: Mar. 1, 2007

(54) Context discovery for DNS names

(75) Inventors: Heikki V. Ollikainen, Espoo (FI); Hannu Flinck, Helsinki (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/211,178

(22) Filed: Aug. 24, 2005

(51) Int. Cl. G06F 15/173; G06F 15/16

(52) U.S. Cl. 709/227; 709/224

(57) ABSTRACT

A system and method for deciding in which context a DNS name should be resolved. A SIP server implements presence functionality for use in context discovery of a DNS name. When the terminal is aware of the context to which the DNS name is related, the terminal may perform a correct DNS lookup for the specific DNS name and context. The DNS resolve library may be modified with the context for the DNS name.

### FIELD OF THE INVENTION

The present invention relates generally to the field of DNS name resolution. Specifically, the present invention relates to combining DNS name resolution with context information from a presence server.

### BACKGROUND OF THE INVENTION

While the evolution of the Internet and mobile technologies has been generally convergent, the distinctions between mobile user needs and stationary user needs create a conflict. Identifiers are constantly increasing in the mobile terminal, as different terminal and user specific identifiers are used in different situations. These identifiers include domain name system (DNS) names (i.e., host names or domain names), email, and Session Initiation Protocol (“SIP”) addresses. Furthermore, current research efforts are aiming to introduce DNS names as part of mobile terminals and mobile networks. For example, the mobile Top Level Domain (mTLD) is a new TLD where mobile content and services can easily be discovered for mobile users. One of the goals of mTLD is to differentiate local and global services for mobile users; local (mTLD) DNS names are only resolved locally (i.e., not visible to public network) whereas global (mTLD) DNS names are resolved globally (i.e., visible to public network). Therefore, this currently would result in a name conflict in the scope of mTLD—i.e., which host names are resolved in which context (local or global).

Users rely on the host name, i.e., the alphanumeric names assigned to an Internet host, such as “www.uspto.gov,” to navigate the Internet. While users rely on the use of host names, the equipment and software which forms the Internet rely on IP addresses, i.e., the 32-bit number which uniquely identifies each Internet host. The DNS is tasked with translating the host name to an IP address so that the user can be routed to the appropriate Internet host. The DNS is a distributed database implemented in DNS servers organized hierarchically. The DNS is an application-layer protocol which allows terminals to query the distributed database to resolve a host name by matching the host name to an IP address. Resolution is accomplished by a combination of computers and software which use the data in the DNS to determine which IP numbers correspond to a particular domain name.

The first level in the DNS hierarchy is the local domain name server. The local domain name server performs two functions. First, it is the first level of IP-address help for Internet service requests coming from terminals within its own domain. Second, the local domain name server is also the final authorized source of information for all requests for IP addresses and host names that fall within its domain. When a terminal makes a request to the DNS, several steps occur. If the requested host name is local, i.e., it is located in the local domain name server's local domain, then the local domain name server is able to provide the address. If the host name is not in the local domain, the local domain name server will check its cache to determine if the host name was recently queried. If the host name is in the cache, the local domain name server is able to provide the address. If the host name isn't in the cache, then the local domain name server passes the host name up to the next level of the hierarchy. The host name query is passed up the hierarchy until an address is provided. If no DNS can be found that is authorized for the host name's domain, or if the authorized DNS for that domain does exist but declares that the host name doesn't exist, a message as such is returned instead of the IP address.

Local names are DNS names that are not globally visible, i.e., they are only resolvable by the local DNS or have a different resolution in the local DNS compared to the overall DNS infrastructure. The need for locally resolved DNS names is based on the network access and subscription limitations, as well as constantly increasing security needs. These factors are particularly true for mobile users. Local DNS name resolution would push forward the creation of local services that are available for end-users in local (or operator) networks. In addition, local names will add value into mobile specific service offering and discovery, and possibly attract more mobile users than traditional Internet services that do not notify well enough the limited resources of mobile devices. Mobile users need to be able to determine the appropriate local DNS server to allow for resolution of local DNS names in the appropriate context. Thus, there is a need for a method and apparatus to combine DNS name resolution with context information to determine whether names are locally resolvable.

### SUMMARY OF THE INVENTION

The present invention provides methods and systems for DNS name resolution with context information from a presence server. The context for the terminal provides a starting point for resolving DNS names. The presence server includes a profile for each domain where a user can register itself to the presence server. The profile includes the context configuration such as the address of the DNS server in the current network that the user should be using.

The present invention provides local name resolution. For example, where a mobile device is connecting to the Internet, a user is able to access presence information to provide a profile indicating the local DNS server to use. With the context from the presence server, host names can be resolved on the appropriate local DNS server. In addition, the use of presence information in this manner provides increased security and functionality to mobile users.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a generic system within which the present invention may be implemented;

FIG. 2 is a perspective view of a mobile telephone that can be used in the implementation of the present invention;

FIG. 3 is a schematic representation of the telephone circuitry of the mobile telephone of FIG. 2;

FIG. 4 is a depiction of an overall system of one embodiment of the present invention;

FIG. 5 illustrates a SIP presence that includes the context DNS server's address in accordance with the principles of the present invention;

FIG. 6 illustrates IP connectivity and the location of a presence server for one embodiment of the invention;

FIG. 7 depicts system architecture for one embodiment of the present invention; and

FIG. 8 illustrates an exemplary embodiment of DNS name and context discovery.

### DETAILED DESCRIPTION OF THE PREFERRED EMBODIMENTS

The present invention relates to systems and methods for determination of which context a DNS name should be resolved. A presence indication provides the context for a terminal regarding where to start resolving a DNS name. When a terminal is aware of the context to which the DNS name is related, it may perform the correct DNS lookup for the specific DNS name. In one embodiment, context includes any information that can be used to characterize a situation.

In one embodiment, mobile phone users can publish their current presence information and fetch the presence information of other users of the service. Presence information or context includes, for example, the user or terminal's availability, location, and communication preferences. The presence service is provided by the operator, but the user has full control over the information that they share with other users. In one embodiment, a SIP server that implements presence functionality is used for context or location discovery of a DNS name.

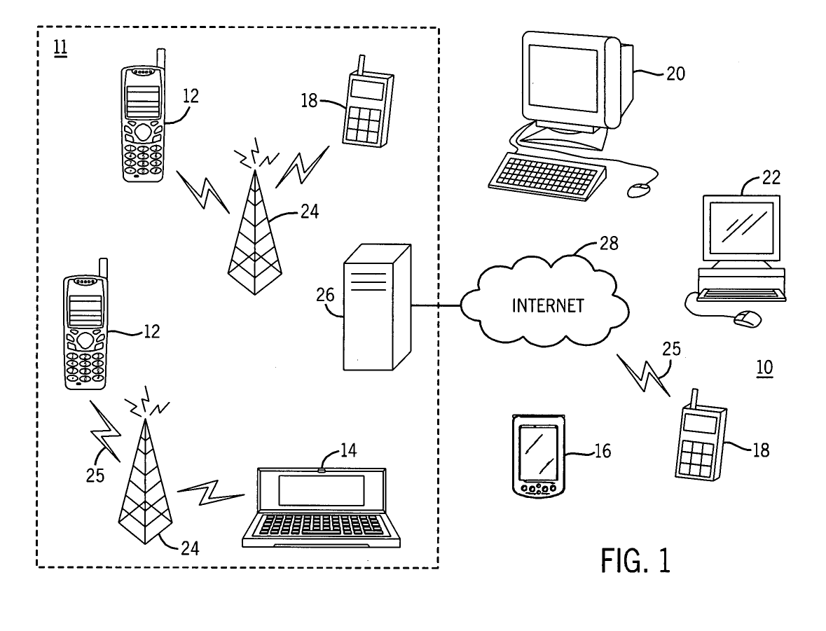

FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile, as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages, and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

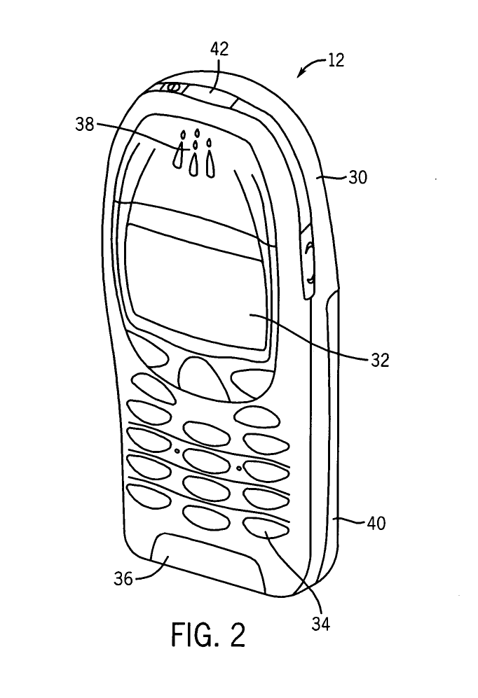

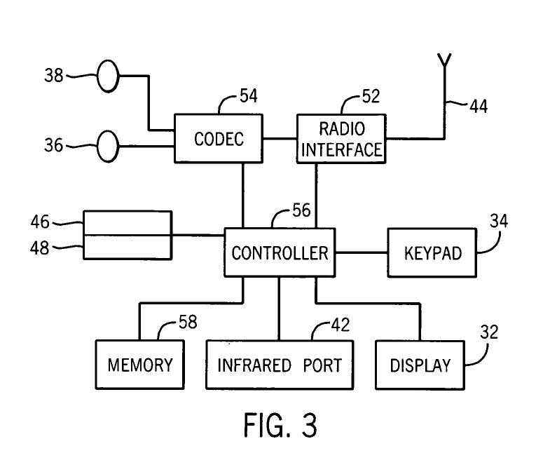

FIGS. 2 and 3 show one representative mobile telephone 12 within which the present invention may be implemented. It should be understood, however, that the present invention is not intended to be limited to one particular type of mobile telephone 12 or other electronic device. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC, according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

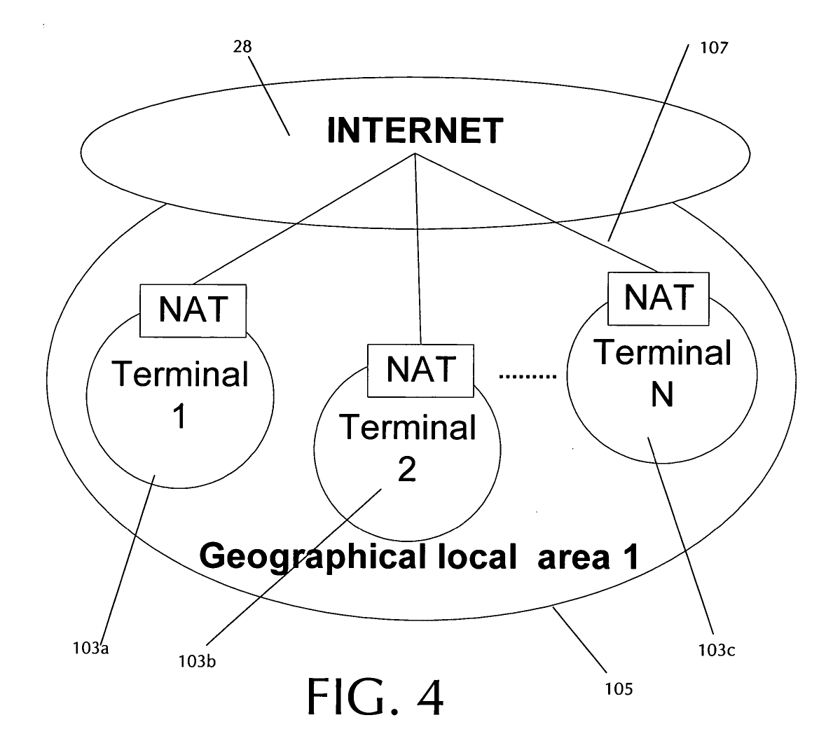

FIG. 4 represents an overall system of one embodiment of the present invention. Each user 103(a), (b), and (c) is located in a local area 105, such as a geographic region. The users 103(a)-(c) are present on a local area network (“LAN”) which communicates with the Internet 28 via network address translation (“NAT”). NAT, also known as network masquerading or IP-masquerading, is a technique in which the source and/or destination addresses of IP packets are rewritten as they pass through a router or firewall. This technique is most commonly used to enable multiple hosts on a private network to access the Internet using a single public IP address. NAT modifies outgoing network packets so that the return address is a valid Internet host. Return (incoming) packets have their destination address changed back, and are relayed to the client host, thereby protecting the private addresses from public view. The individual LANs are connected to the internet 28 via connections 107. If user 103(a) were operating a mobile device, such as an Internet-enabled mobile telephone, the user 103(a) may very well move out of the local area 105, i.e., leave the geographic boundary of the local area 105.

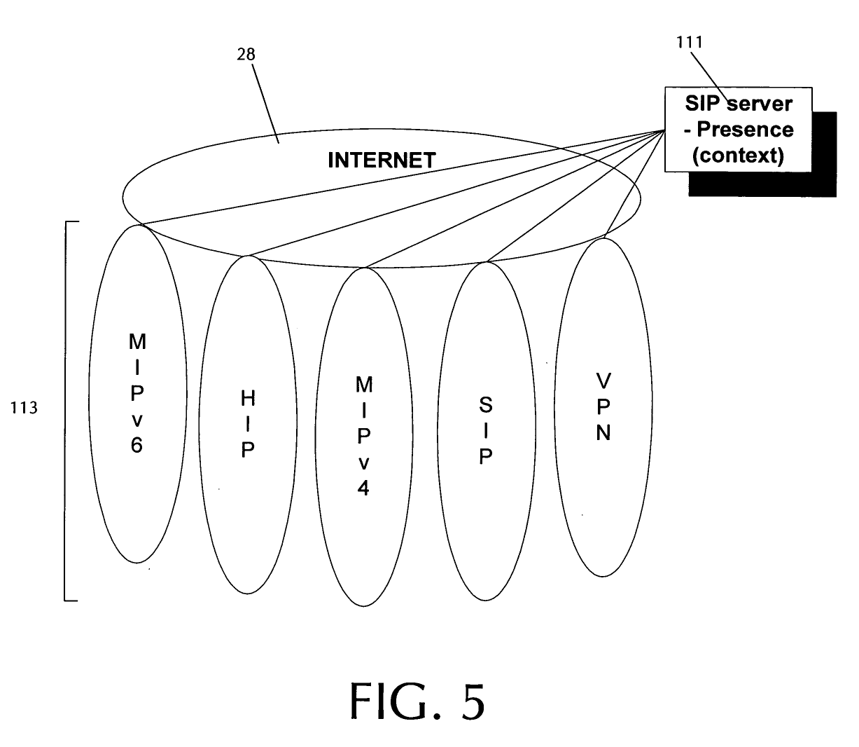

In one embodiment, the presence server is located in a public network, such as the Internet, i.e., it is available for public use. FIG. 5 presents one embodiment of the invention wherein the presence server 111 has connectivity within the variety of networks 113 in the Internet 28. While MIPv6, MIPv4, HIP, VPN, and SIP are shown in FIG. 5, the present invention is not limited to any specific type of domain or network.

In the present invention, each terminal 103(a)-(c) (or user) updates its presence status into the SIP presence server 111 and receives the DNS-specific context related to the current network location of the terminal. In one embodiment, the contexts are pre-defined into the SIP presence server 111. For example, if the terminal is in virtual private network (“VPN”), then the terminal updates its status into the presence server and receives DNS-specific context related to the VPN network. If a DNS server is located in the VPN, the terminal will use the VPN DNS server as a local DNS server for the initial step of host name resolution.

In one embodiment of the invention, the SIP presence server 111 includes at least one profile for a user. The profile is a collection of all of the available context information for each respective user. In one embodiment, the profile contains pointers to a context information location and/or actual context information. In an exemplary embodiment, a pre-defined extensible Markup Language (“XML”) profile is provided for each service deployment environment (i.e., domain) where a user can register itself to presence. XML is a document markup language for defining structured information. Structured information is simple information that has more to it than the actual text itself (i.e., body type). XML is a language used by computers to define hidden information about the structure of the document. XML can be understood as Meta language where one can use XML to create tags for defining documents, or use tag languages created with XML for compatibility across the Internet. The XML profile includes the context configuration, such as the address of a DNS server, or servers, in the current network that the terminal should be using. In one embodiment, each context (e.g., MIPv6, MIPv4, HIP, VPN, and SIP) can be separated with a XML namespace that is identified with Universal Resource Identifier (“URI”).

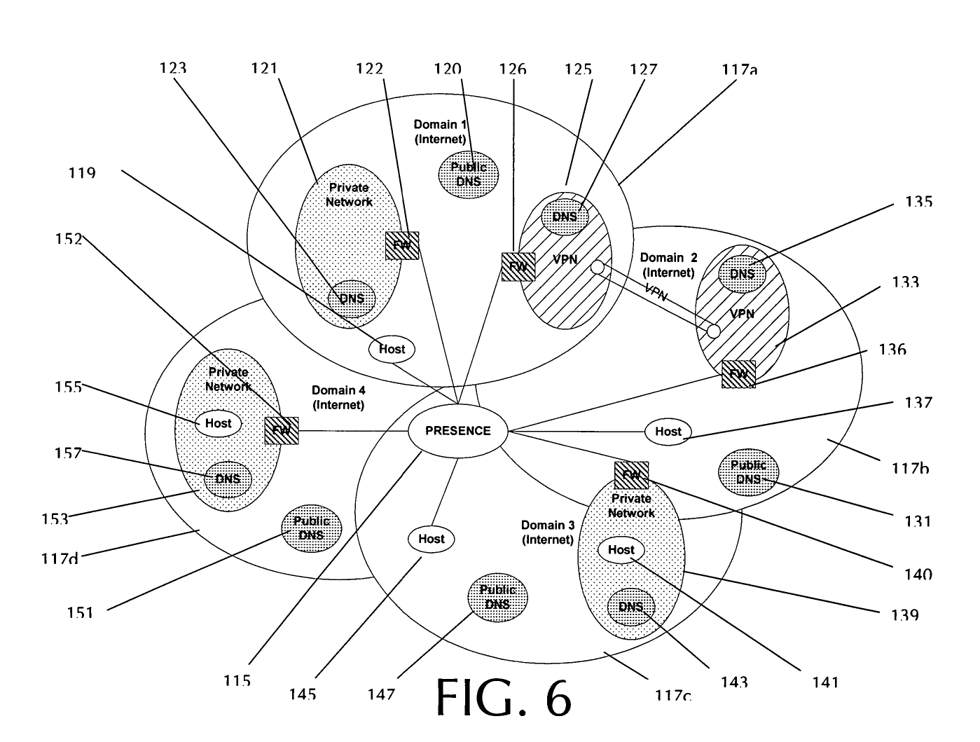

FIG. 6 illustrates the connectivity within the variety of networks in the Internet 28 for one embodiment of the invention. The presence server 111 is connected to a variety of networks or domains 117(a)-(d). The first domain 117(a) includes a first domain host 119 and a first domain public DNS server 120, as well as a first domain private network 121 and a first domain virtual private network (VPN) 125. The first domain private network 121 is located behind a first domain private network firewall 122 with a first domain private network DNS server 123. The first domain VPN 125 is also positioned behind a first domain VPN firewall 126 and contains a first domain VPN DNS server 127. The first domain VPN 125 is in communication with a second VPN 133, a second domain VPN 133, which is located behind a second domain VPN firewall 136, in the second domain 117(b). The second domain VPN 133 includes a second domain VPN DNS server 135. The second domain 117(b) also includes a second domain host 137, a second domain public DNS server 131, and a second domain private network 139. The second domain private network 139 is located behind a second domain private network firewall 140 in the second domain 117(b), but straddles both the second domain 117(b) and third domain 117(c). The second domain private network 139 includes a second domain private network host 141 and a second domain private network DNS server 143.

The third domain 117(c) further includes a third domain host 145 and a third domain public DNS server 147. The fourth domain 117(d) comprises a fourth domain public DNS server 151 and fourth domain private network 153 behind a fourth domain private network firewall 152. The fourth domain private network 153 includes a fourth domain private network host 155 and a fourth domain private network DNS server 157. All of the hosts and networks include a connectivity to the presence server 111. In one embodiment, the presence server 111 includes context for each user/terminal for each domain and/or network 117(a)-(d).

In one embodiment of the invention, the present invention comprises a network. In an exemplary embodiment, the network includes 1) a SIP presence server that is located in the public Internet, 2) a mechanism to create a XML profile into the presence server (i.e., new software or modifications to the SIP server), and 3) a pre-defined XML profile for each service deployment environment (domain) where a user can register itself into a presence server. Context is identified with a unique URI for each configuration.

In one embodiment, the initial XML service profile deployment in presence server includes the following code. However, various permutations of code could be used in accordance with the principles of the present invention.

<?xml version=″1.0″ encoding=″UTF-8″?>

<impp:presence xmlns:impp=″urn:ietf:params:xml:ns:pidf″

xmlns:mycontext1=http://domain1..com/
xmlns:mycontext2=http://domain2.com/
xmlns:mycontext2=http://domain3.com/
xmlns:mycontex2=http://domain4.com/
entity=″pres:user1@PrimaryEmail.com″>

<impp:tuple id=″ck38g9″>

<impp:status>

<impp:basic>closed</impp:basic>
<mycontext1:Network>MIPv6</mycontext1:Network>
<mycontext2:Network>MIPv4</mycontext2:Network>
<mycontext3:Network>HIP</mycontext3Network>
<mycontext4:Network>VPN</mycontext4:Network>

</impp:status>

<impp:contact

priority=″0.65″>tel:+0501234567</impp:contact>

</impp:tuple>
<impp:tuple id=″md66je″>

<impp:status>

<impp:basic>closed</impp:basic>
<mycontext1:Network>MIPv6 network

2</mycontext1:Network>

<mycontext2:Network>Private network

2</mycontext2:Network>

<mycontext3:Network>HIP network

2</mycontext3:Network>

<mycontext4:Network>Private network

1</mycontext4:Network>

</impp:status>

<mycontext1:LocalAreaPreference>_mipv6._tcp.example.com
</mycontext1:LocalAreaPreference>
<mycontext2:LocalAreaPreference>_mipv4._tcp.test.net</myc
ontext2:LocalAreaPreference>
<mycontext3:LocalAreaPreference>_hip._tcp.test.net</mycont
ext2:LocalAreaPreference>
<mycontext4:LocalAreaPreference>_privatenetwork1._tcp.test.
net</mycontext2:LocalAreaPreference>

<impp:contact

priority=″1.0″>im:user1@domain2.test.net</impp:contact>

</impp:tuple>

<mycontext1:mytag>Hello, I am in MIPv6

network</mycontext1:mytag>

<mycontext2:mytag>Hello, I am in MIPv4

network</mycontext2:mytag>

<mycontext3:mytag>Hello, I am in HIP

network</mycontext2:mytag>

<mycontext4:mytag>Hello, I am in VPN (private network

1) network</mycontext2:mytag>
</impp:presence>

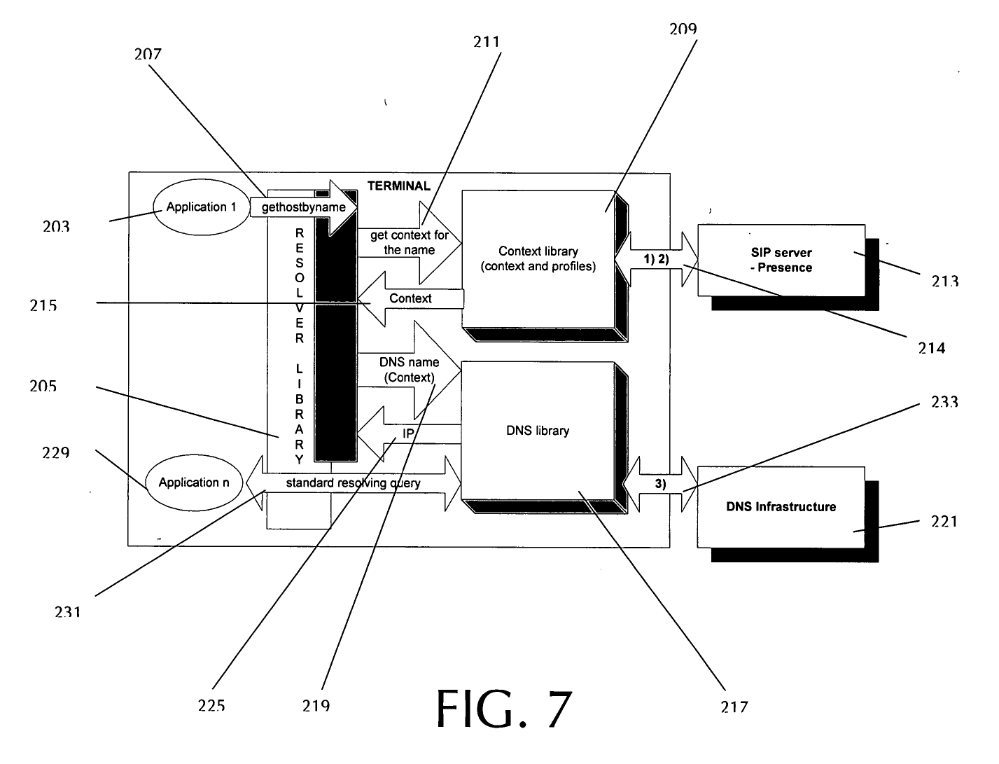

In one embodiment, the present invention comprises a terminal. In an exemplary embodiment, the terminal includes functionality for modification of the DNS resolve library, as shown in FIG. 7. In one embodiment, the DNS resolution and context discovery should be invisible from the terminal (i.e., the user's) perspective.

In one exemplary embodiment, the presence functionality is included in the existing DNS resolve function (for example, “gethostbyname”) with an error handling procedure. Thus, in this embodiment, the terminal is forced to use new functionality in accordance with the principles of the present invention, namely, context based DNS resolution.

In another exemplary embodiment, a new function is created in the resolve library (for example, “gethostbycontext”). However, this requires that terminal applications be required to call the new function specifically when needed. In one embodiment, a user may call a conventional function to perform a non-context (i.e., standard) DNS name resolution.

FIG. 7 illustrates a flow chart showing the operation of an exemplary embodiment of the present invention. A first application 203 queries the DNS resolver library function 205 (such as described above) is called at step 207. The resolver library function 205 calls the context library function 209 at step 211. The context library 209 is in communication with the SIP server 213. In one embodiment, a presence registry is created by the handover of the terminal to a new domain or by a location tracking function. In another embodiment, the SIP presence provides context with services preferences (i.e., profiles) which are used in the current local domain. In an exemplary embodiment, profile information for other domains is also provided. The context library function 209 provides context to the resolver library 205 at step 215. Using the correct context, the DNS resolver library 205 performs the DNS lookup by calling the DNS library 217 for the DNS name at step 219. In one embodiment, the DNS library 217 communicates with the DNS infrastructure 221 at step 223 to perform a standard DNS lookup, using the correct context from the context library 209. At step 225, the DNS library 217 returns the IP address for the context supplied for the queried host name. In one embodiment, a second application 229 may query the resolver library 205 in the standard manner, wherein the resolver library 205 communicates at step 231 with the DNS library 217 to resolve the host name without context.

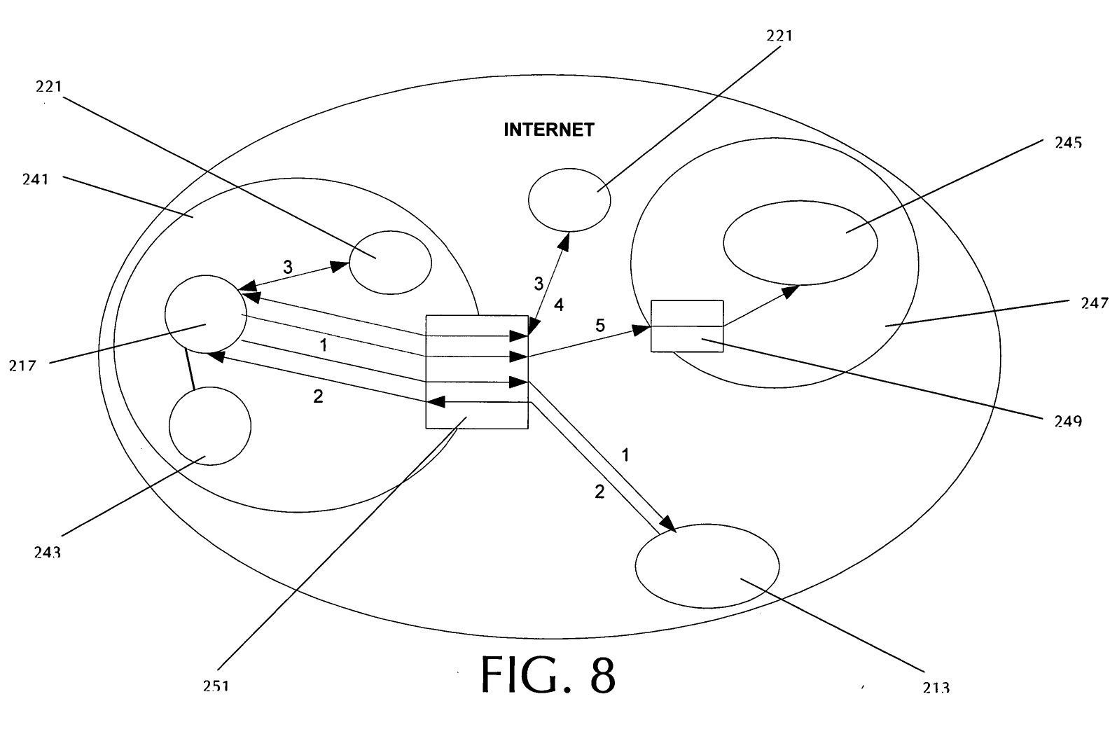

FIG. 8 illustrates an exemplary embodiment of the present invention wherein a terminal 243 seeking to resolve a host name is located in a private network 241 which has a firewall 251 through which the terminal 243 communicates with the Internet 28. The terminal 243 passes the host name of a destination host 245 to the DNS resolve library 217. First, the DNS resolve library 217 contacts the presence server 213. The DNS resolve library 217 then receives the destination context (the MIPv6 network 247). At this point, resolver library 217 is aware that the DNS name needs to be resolved in the MIPv6 context. The resolver library 217 contacts the DNS infrastructure 221 for resolving the IP address of a destination 245. The terminal 243 receives the destination IP address 245. The terminal 243 may then try connecting to the destination 245, in the embodiment shown in FIG. 8, via the home address 249.

The present invention is described in the general context of method steps, which may be implemented in one embodiment by a program product including computer-executable instructions, such as program code, executed by computers in networked environments. Generally, program modules include routines, programs, objects, components, data structures, etc., that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of deciding in which context a domain name system name should be resolved comprising:
querying a domain name system resolver with a host name to resolve;
querying a context library for context information;
receiving the context information from the context library in response to the context query;
querying a domain name system for the IP address corresponding to the host name; and
receiving from the domain name system the IP address for the context information supplied for the queried host name in response to the domain name query.

2. The method of claim 1, wherein the context library is in communication with a SIP server that implements presence functionality.

3. The method of claim 2, further comprising updating the context library from the SIP server.

4. The method of claim 1, further comprising providing context profiles to the domain name system resolver.

5. The method of claim 4, wherein the context profile contains information for one domain.

6. The method of claim 4, wherein the context profile contains information for a plurality of domains.

7. The method of claim 1, wherein the context information comprises information selected from the group consisting of availability, location, communication preferences, and combinations thereof.

8. A system for deciding in which context a DNS name should be resolved, comprising:
a terminal located within a domain and including a DNS resolve library;
a SIP presence server operatively connectible with the DNS resolve library, the SIP presence server including a profile; and
DNS infrastructure in communication with the DNS resolve library;
wherein the SIP presence server provides context for modification of the DNS resolve library for resolution of the DNS name via the DNS infrastructure using the provided context.

9. The system of claim 8, wherein the profile comprises an extensible markup language profile.

10. The system of claim 8, wherein the profile contains information for the domain.

11. The system of claim 8, wherein the profile contains information for a plurality of domains.

12. A computer program product comprising:
computer code for querying a domain name system resolver with a host name to resolve;
computer code for querying a context library for context information;
computer code for receiving the context information from the context library in response to the context query;
computer code for modifying the domain name system resolver with the context information;
computer code for querying a domain name system for the IP address corresponding to the host name; and
computer code for receiving from the domain name system the IP address for the context information supplied for the queried host name in response to the domain name query.

13. The computer program product of claim 12, further comprising computer code for updating the context library from a SIP server.

14. The computer program product of claim 12, further comprising computer code for providing context profiles to the domain name system resolver.

15. The computer program product of claim 12, further comprising computer code wherein the context information comprises information chosen from the group consisting of availability, location, communication preferences, and combinations thereof.

16. A method of modifying a domain name system resolver comprising:
querying a domain name system resolver of a terminal with a host name to resolve;
communicating with a presence server for context information concerning the terminal;
modifying the domain name system resolver with the context information for the terminal from the context library;
querying a domain name system for the IP address corresponding to the host name; and
receiving the IP address for the context information supplied for the queried host name from the DNS.

17. The method of claim 16, wherein the querying of the domain name system resolver comprises querying for resolution of the host name by context.

18. The method of claim 16, further comprising providing at least one context profile to the domain name server resolver.

19. A method of providing presence information for resolution of a domain name system name comprising:
receiving a query for presence information from a domain name system resolver with a host name to resolve; and
providing context information from the context library to the domain name system resolver in response to the query.

20. The method of claim 19, further comprising:
querying a domain name system for an IP address corresponding to the host name; and
returning from the domain name system the IP address for the context information supplied for the queried host name
